(19) United States
(12) Patent Application Publication
(10) Pub. No.: US 2007/0058613 A1
(43) Pub. Date: Mar. 15, 2007

(54) Integrating telephonic service subscribers

(75) Inventor: David Scott Beckemeyer, Danville, CA (US)

Correspondence Address: SMITH FROHWEIN TEMPEL GREENLEE BLAHA, LLC, P.O. BOX 88148, ATLANTA, GA, 30356, US

(73) Assignee: TelEvolution Incorporated

(21) Appl. No.: 11/227,734

(22) Filed: Sep. 15, 2005

(51) Int. Cl. H04L 12/66

(52) U.S. Cl. 370/352

(57) ABSTRACT

A telecommunication system comprises a first interface, a second interface, and a voice-over-Internet device. The first interface enables a telephonic handset coupled to the voice-over-Internet device to communicate via a phone service. The second interface enables the telephonic handset to communicate via a data network coupled to the voice-over-Internet device. The voice-over-Internet device is configured to modify the phone service. The voice-over-Internet device exposes services provided over the data network to service subscribers. As a result, a mobile or wired telephone service customer can subscribe to add-on services provided by a service provider over the data network without the knowledge or permission of the existing telephone service company.

### CROSS-REFERENCE To RELATED APPLICATIONS

This application is related to co-pending U.S. utility patent application entitled “Telephone Number Binding in a Voice-Over-Internet System,” filed on Oct. 13, 2004 and accorded application Ser. No. 10/964,518, which is incorporated by reference herein in its entirety. This application is further related to co-pending U.S. utility patent application entitled “Integrating Telephonic Service Providers,” filed on Jun. 21, 2005 and accorded application Ser. No. 11/157,643, which is incorporated by reference herein in its entirety.

### BACKGROUND OF THE INVENTION

1. Field of the Invention

Systems and methods that relate generally to the provision of telephonic services are invented and disclosed.

2. Related Art

Presently, there are a number of solutions that enable customers to place telephone calls over the Internet, rather than over the public-switched telephone network (PSTN). Internet telephony services (e.g., voice-over-Internet-Protocol (VoIP), voice-over-digital-subscriber-line (VoDSL), voice-over-asynchronous-transfer-mode (VoATM), etc.) have become much more prevalent as the number of broadband connections at residential locations has increased.

One of the earliest Internet telephony solutions is a “soft phone.” A soft phone is computer software that may be installed on a typical personal computer. The computer software enables any computer device with a speaker and a microphone to place free Internet calls through an Internet service provider (ISP). Soft phones, however, suffer from various disadvantages and problems. For example, in many cases, soft phones only enable a user to make free Internet calls to other users that have installed the same or similar software on their computer. Furthermore, these software-based solutions offer no or limited calling to the public switched telephone network (PSTN).

Another Internet telephony solution employs service providers (e.g., Internet telephone service providers (ITSP)) that offer voice-over-Internet services to subscribers. An ITSP usually provides the subscribers with supporting hardware. The supporting hardware may comprise a stand-alone device manufactured by another company (e.g., a VoIP phone) that connects to the Internet. The supporting hardware, software, etc. may also include other equipment that functions as an interface between the customer's telephone and the Internet. Typically, the ITSP sells or leases the hardware to the subscriber and charges the customer a monthly service fee for the services. In some cases, the potential subscriber may purchase the hardware from another entity and then request service from the ITSP.

ITSP solutions also have a number of disadvantages. Many customers have been slow to adopt this approach because they are unwilling to abandon their traditional phone service. For example, a number of alarm systems, satellite television, and other services rely on a connection to the PSTN. The PSTN typically functions even through widespread electrical service outages. The PSTN is not adversely affected by ISP or ITSP service outages. More importantly, emergency calls accessed by dialing “911” from a VoIP solution often do not provide the emergency operator with information that can be used to locate the caller.

Another problem associated with VoIP services is associated with the business model that VoIP service providers have used to market their product. The common business model in VoIP services is a “landline replacement” model, in which service providers attempt to mimic the traditional PSTN service. Users are expected to replace their traditional PSTN service for the lower fee offered by the ITSP for long-distance and other services. Thus, customers with traditional alarm, satellite television, and other services that use the PSTN will be slow to adopt an additional service absent a compelling economic reason.

Accordingly, despite the growth of Internet telephony services and products there is still a need for improved voice-over-Internet solutions.

### SUMMARY

An embodiment of a telecommunication system comprises first and second interfaces and a voice-over-Internet device. The first interface enables a telephonic handset coupled to the voice-over-Internet device to communicate via a phone service. The second interface enables the telephonic handset to communicate via a data network. The voice-over-Internet device is coupled to the first and second interfaces and is configured to modify the phone service.

Related methods are also provided. An embodiment of a method for exposing telephonic service subscribers to service providers is also invented and disclosed. The method comprises providing a subscriber voice-over-Internet device at the edge between both the public switched telephone network and a data network and a telephonic device coupled to the subscriber voice-over-Internet device at a subscriber premise, providing a voice-over-Internet platform coupled to both the PSTN and the data network, the voice-over-Internet platform comprising a device interface that defines mechanisms for configuring and operating the subscriber voice-over-Internet device at the subscriber premise and a data network interface comprising a front-office solution, and coupling the subscriber voice-over-Internet device to the voice-over-Internet platform to complete a service provider-to-subscriber channel that bypasses a plain old telephone system service provider and enables a service provider to promote and enable telephonic services operable at the telephonic device through the voice-over-Internet platform.

Other systems, methods, features, and advantages will be or will become apparent to one with skill in the art upon examination of the following figures and detailed description. All such additional systems, methods, features, and advantages are defined and protected by the accompanying claims.

### BRIEF DESCRIPTION OF THE FIGURES

The systems and methods for integrating telephonic service subscribers can be better understood with reference to the following figures. The components within the figures are not necessarily to scale, emphasis instead being placed upon clearly illustrating the principles used to integrate telephonic service subscribers with service providers via an integration platform coupled to a data network. Moreover, in the figures, like reference numerals designate corresponding parts throughout the different views.

FIG. 1 is a block diagram illustrating an embodiment of a system for integrating telephonic service providers to subscribers of a voice-over-Internet service.

FIG. 2 is a block diagram illustrating an embodiment of the subscriber voice-over-Internet device of the system of FIG. 1.

FIGS. 3A-3C are block diagrams illustrating embodiments of signaling and communication paths for processing calls using components of the system of FIG. 1.

FIG. 4 is a functional block diagram illustrating an embodiment of the voice-over-Internet platform of FIG. 1.

FIG. 5 is a schematic diagram illustrating the linking of a telephone number to a subscriber voice-over-Internet device identifier by the voice-over-Internet platform of FIG. 1.

FIG. 6 is a schematic diagram illustrating an embodiment of an operational environment in which the integration system of FIG. 1 and the subscriber voice-over-Internet device of FIG. 2 enable landline customers to subscribe to services from non-traditional service providers.

FIGS. 7A and 7B are schematic diagrams illustrating embodiments of a channel for providing telephonic services that bypasses an existing telephone service provider.

FIGS. 8A-8C are graphical user interfaces illustrating example embodiments of interfaces generated by the front-office solution of the data network interface of FIG. 4.

FIGS. 9A and 9B are graphical user interfaces illustrating example embodiments of application programming interfaces generated by the computer of FIG. 1.

FIG. 10 is a flow diagram illustrating an embodiment of a method for exposing telephonic service subscribers to service providers that can be implemented by the system of FIG. 1 and the subscriber voice-over-Internet device of FIG. 2.

### DETAILED DESCRIPTION

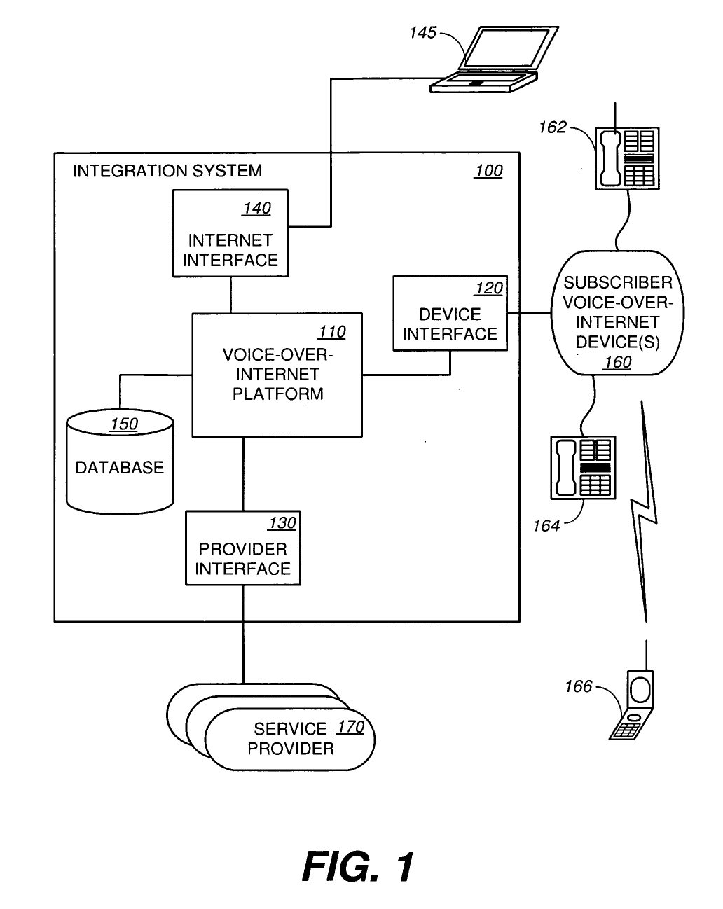

Various embodiments of telecommunication systems, methods, and computer programs, etc. that combine a subscriber voice-over-Internet device located within a customer premise with a remotely located voice-over-Internet platform to modify a phone service will be described with respect to FIGS. 1-10. With regard to all described embodiments, it should be appreciated that the term “voice-over-Internet” is not limited to any particular protocol, transmission medium, communications network, topology, architecture, etc. Rather, “voice-over-Internet” applies to any system that supports telephone calls between two or more individuals via a data network. By way of example, voice-over-Internet should be construed to include existing and future Internet telephony services, such as voice-over-Internet-Protocol (VoIP), voice-over-digital-subscriber-line (VoDSL), voice-over-asynchronous-transfer-mode (VoATM), etc. Furthermore, it should be understood that the voice services need not be provided over a public data network but, rather, may also be provided over a private data network, such as a local area network, a proprietary wide area network, etc., to name a few examples.

The exemplary integration system for providing voice-over-Internet services comprises a voice-over-Internet platform which supports communications with one or more voice-over-Internet devices each located at a customer premise. The subscriber voice-over-Internet device communicates with other destination devices using one or more traditional telephonic service providers such as a POTS service provider via a traditional telephone landline or a wireless service provider via a wireless communication device and a broadband data service provider, such as an Internet service provider. The subscriber voice-over-Internet device is configured to connect POTS calls via the POTS service provider to a telephonic device coupled to the PSTN. The subscriber voice-over-Internet device is also configured to connect cellular or other wireless network calls via a wireless service provider to a telephonic device coupled to the wireless network. The subscriber voice-over-Internet device is further configured to connect voice-over-Internet calls via the data network with similarly configured combinations of voice-over-Internet devices and telephonic devices.

The subscriber voice-over-Internet device is a plug-n-play device. That is, once the subscriber has connected the device, the device has completed a self-initialization or bootstrap procedure and a one-time activation procedure to configure the device; the subscriber can initiate and receive calls. The subscriber voice-over-Internet device is well-suited for distribution and marketing through consumer electronic retailers.

Once a communication session is established, the subscriber voice-over-Internet device processes both POTS and voice-over-Internet calls as if the calls are voice-over-Internet calls. Thus, an appropriately configured subscriber voice-over-Internet device can provide VoIP like add-on services that are operable even when a present call is being communicated from the subscriber voice-over-Internet device to a destination device over the PSTN or a wireless network.

The subscriber voice-over-Internet device is configured to monitor calls initiated from or otherwise processed via the subscriber's voice-over-Internet device to determine if a similarly configured device is handling the call at the destination. When it is the case that a similarly configured device is identified on the other end of the call, the subscriber voice-over-Internet device is configured to retrieve and store a device identifier that is linked or bound to the called destination number. Once the link has been established, future calls to the similarly configured device can be initiated and routed over the data network when the data network is available. When the data network is not available, the subscriber voice-over-Internet device initiates and completes the call via the PSTN or an available wireless network.

From the subscriber's perspective, the subscriber voice-over-Internet device is a black-box device that may be easily configured (and, in some embodiments, automatically configured) for communication with the voice-over-Internet platform. After the device is provisioned, the customer may initiate telephone calls to other individuals without regard to whether the call is being placed over a traditional phone service or the data network. The subscriber voice-over-Internet device and the voice-over-Internet platform perform the logical functions necessary to support standard PSTN, wireless, and voice-over-Internet calls.

The voice-over-Internet platform associates (e.g., links, binds, relates, etc.) the existing telephone number to the customer voice-over-Internet device. In this manner, the voice-over-Internet platform may develop and maintain a database containing information that links a particular customer voice-over-Internet device to the existing telephone number. The association between the existing telephone number and the customer voice-over-Internet device enables the voice-over-Internet platform to establish voice-over-Internet calls between customers. For example, when a calling customer associated with a first customer voice-over-Internet device attempts to place a call to a particular PSTN telephone number, the voice-over-Internet platform may determine whether the customer at that particular PSTN telephone number has been provisioned by the voice-over-Internet platform. The voice-over-Internet platform may access the database and determine whether the PSTN telephone number has been associated with a second customer voice-over-Internet device. If the PSTN telephone number does not have a corresponding customer voice-over-Internet device, the first customer voice-over-Internet device may use the PSTN to place the call to the called customer. However, in the event that the called customer has previously provisioned a second customer voice-over-Internet device (and, therefore, the voice-over-Internet platform has a database record or other data structure associating the PSTN telephone number to the customer voice-over-Internet device), the voice-over-Internet platform may orchestrate a voice-over-Internet call between the calling customer and the called customer via the respective customer voice-over-Internet devices.

The voice-over-Internet platform is configured with a device interface, a provider interface, and an internet interface. The device interface defines the mechanisms available to the subscriber voice-over-Internet devices for communicating with the integration system. Because the subscriber voice-over-Internet device works together with the voice-over-Internet platform, functionality can be physically located as may be desired anywhere across the network. The provider interface defines the mechanisms that are available to outside programmers or service providers for introducing their services to the subscribers. The provider interface comprises a host of functional modules that register, authenticate, and manage relationships with service providers. The provider interface further comprises modules that manage the introduction, verification, and distribution of service applications and client components. The Internet interface includes one or more graphical-user interfaces (GUIs) that are configured to manage subscriber accounts and market potential services. The Internet interface also includes one or more GUIs configured to market and manage relationships and accounts with present and potential service providers. The Internet interface of the voice-over-Internet platform provides both front-office and back-office solutions to subscribers, potential subscribers, service providers, and potential service providers. Front-office solutions include marketing, e-commerce, subscriber account management and similar functions. Back-office solutions include offering and accepting of business relationships with service providers, processes for registering and verifying potential services, collecting subscriber usage statistics, etc.

The subscriber voice-over-Internet device is configured to receive one or more client components configured to enable add-on services that can be operative with all calls handled by the device. The client components are supplied via the data network under the control and management of the voice-over-Internet platform. The client components and the device interface work together to handle and manage all services provided to the subscribers' telephones coupled to the subscriber voice-over-Internet device.

While add-on services can be created by a voice-over-Internet service provider or the manager of a localized data network, the above-described combination provides a mechanism for exposing consumers of both traditional landline and voice-over-Internet services to non-traditional service providers who have been prohibited from reaching these potential clients by the traditional telephone and voice-over-Internet service providers.

Having described the general operation of an exemplary integration system for providing voice-over-Internet add-on services, various additional embodiments will be described with respect to FIGS. 1-10. FIG. 1 is a block diagram illustrating an embodiment of an integration system 100 that exposes subscriber voice-over-Internet devices 160 to telephonic service providers 170. As illustrated in FIG. 1, voice-over-Internet platform 110 resides at the core of the integration system 100. Voice-over-Internet platform 110 couples and manages the various functions associated with each of the provider interface 130, device interface 120, internet interface 140, and database 150. Device interface 120 defines the mechanisms by which subscriber voice-over-Internet devices 160 communicate with telephonic devices via the PSTN and a data network. Provider interface 130 defines the mechanisms that are available to outside programmers or service providers for introducing their services to the subscribers or users of telephonic devices, such as telephone 162, telephone 164, and wireless phone 166, coupled to the subscriber voice-over-Internet devices 160. Provider interface 130 comprises a host of functional modules that register, authenticate, and manage relationships with service provider(s) 170. Provider interface 130 further comprises modules that manage the introduction, verification, and distribution of service applications and client components. Internet interface 140 manages subscriber accounts and markets potential services to present and potential subscribers via computing devices such as computer 145. Internet interface 140 is also configured to market and manage relationships and accounts with present and potential service providers 170. Service providers 170 in some circumstances communicate with integration system 100 via other computing devices (not shown) and Internet interface 140 in lieu of or in addition to provider interface 130. Database 150 is used to store persistent operational, service provider and subscriber information.

The embodiment illustrated in FIG. 1 reveals that integration system 100 is highly flexible in that service providers 170 and subscribers have many different mediums and modes for interacting with integration system 100. For example, subscribers can couple wired telephones, wired base stations with wireless handsets, and cellular phones or any combination of these via subscriber voice-over-Internet devices 160 to integration system 100. In addition, subscribers can communicate with integration system 100 via a computing device coupled to a data network. Communications via computing device 145 include information transfers related to subscription management and for suitably configured computing devices with a handset or the combination of a speaker and a microphone, that are in communication with integration system 100, subscriber calls may be connected and supported from virtually any location. For example, a subscriber can enable an application on their laptop computer from a hotel with data network access to answer and place calls over the subscriber's existing POTS line. As will be described further below, subscriber calls can be connected and controllably modified through one or both of the integration system 100 and each of the subscriber voice-over-Internet devices 160 in real time.

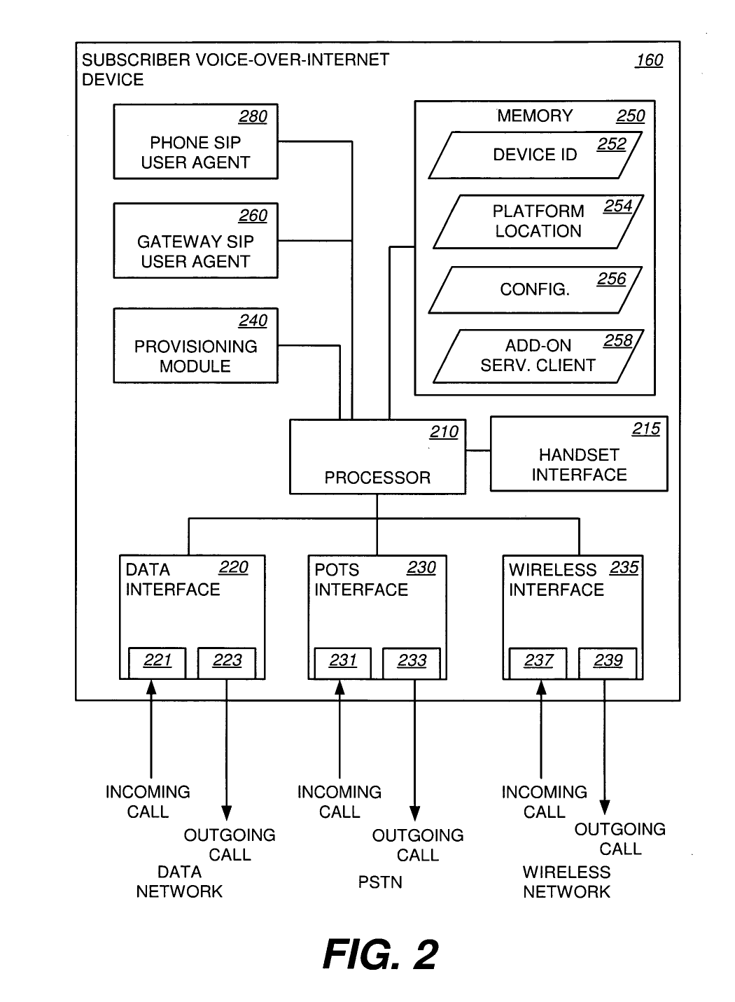

FIG. 2 is a block diagram illustrating an embodiment of the subscriber voice-over-Internet device 160 of the system of FIG. 1, which supports dynamic provisioning with voice-over-Internet platform 110. As illustrated in FIG. 2, subscriber voice-over-Internet device 160 comprises data interface 220, telephone interface (e.g., plain-old-telephone-service (POTS) interface 230), processor 210, handset interface 215, provisioning module(s) 240, memory 250, gateway segment interface protocol (SIP) user agent 260, and phone SIP user agent 280.

Data interface 220 comprises a suitable interface for communicating with voice-over-Internet platform 110 via a data network. It should be understood that a number of data interfaces (using one or more of hardware, software, firmware) may be employed depending on the particular configuration of the data network (not shown). Furthermore, the data network may be a network with an infrastructure that uses a wired media (e.g., Ethernet) or a network based on a wireless infrastructure (e.g., wi-fi).

Handset interface 215 comprises a suitable interface for communicating with a subscriber of a telephony device (e.g., telephone 162, telephone 164, wireless phone 166) via a telephony user interface.

Data interface 220 may be configured to communicate directly with the data network or, in alternative embodiments, may merely communicate with another data interface (e.g., cable modem, DSL modem, etc.) that connects to a data network. Data interface 220 includes ingress port 221 and egress port 223 for handling incoming and outgoing data transfers (signaling information, dual-tone multiple frequency (DTMF) entries, etc.) and call information.

POTS interface 230 comprises any suitable interface for enabling a telephone (not shown) to communicate via the PSTN. POTS interface 230 includes ingress port 231 and egress port 233 for handling incoming and outgoing calls including signaling information, DTMF entries, voice, voice-band data communications and the like. Generally, POTS interface 230 comprises a RJ-11 receptacle coupled via a conductor to a RJ-11 wall jack in a subscriber's residence.

Wireless interface 235 comprises any suitable interface for enabling a cellular or other wireless phone to communicate with a wireless network. Wireless interface 235 includes ingress port 237 and egress port 239 for handling incoming and outgoing calls including signaling information, DTMF entries, voice, voice-band data communications and the like. While the illustrated embodiment shows each of the data interface 220, POTS interface 230, and wireless interface 235 comprising both ingress and egress ports, it should be understood that each of the interfaces may be configured with a respective two-way communication port compatible with the underlying cellular or wireless communication standard(s).

Processor 210 controls the functional operation of various aspects of subscriber voice-over-Internet device 160, including the activities of provisioning module 240, gateway SIP user agent 260, and phone SIP user agent 280. Provisioning module 240 comprises the logic, functionality, etc. for automatically provisioning subscriber voice-over-Internet device 160 via voice-over-Internet platform 110. Provisioning module 240 further comprises the logic, functionality, etc. for enabling dynamic updates of configuration parameters in a secure manner. The stored configuration parameters, in configuration store 256, control the behavior of the subscriber voice-over-Internet device 160, including the behavior of SIP user agent 260, phone SIP user agent 280, and the various interfaces.

Provisioning module 240 is configured to perform configuration updates asynchronously. A request from the data network is delivered to one or both of the gateway SIP user agent 260 and the phone SIP user agent 280. The receiving user agent in turn after authenticating the provisioning server, completes the update process in response to one or more commands from the provisioning server, and the original configuration of the voice-over-Internet device 160. The authentication process and subsequent update commands use public key cryptography, hypertext transfer protocol secure sockets, and client/server certificates to ensure secure control and data transfer.

Gateway SIP user agent 260 includes a client module and a server module (not shown). The gateway SIP user agent 260 registers with a SIP proxy using unique credentials (separate from credentials used with the phone SIP user agent 280) so that it can be addressed individually. Gateway SIP user agent 260 is configured to accept INVITE requests from the data network, perform digest authentication, and route a SIP uniform resource identifier (URI) in accordance with a defined dial plan, which includes placing a call via POTS interface 230. For inbound POTS calls, the gateway SIP user agent 260, initiates a SIP INVITE to a SIP URI specified in the dial plan and forwards or otherwise identifies call handling parameters for processing the calls. In some cases the SIP URI represents the phone SIP user agent 280 of the same subscriber voice-over-Internet device 160.

Phone SIP user agent 280 registers with a SIP proxy using unique credentials (separate from credentials used with the Gateway SIP user agent 260) so that the phone SIP user agent 280 can be addressed individually. Phone SIP user agent 280 is configured to accept INVITE requests from the data network, perform digest authentication, and route a SIP uniform resource identifier (URI) in accordance with a defined dial plan, which includes ringing a connected handset (or other user telephony device). For calls initiated by a subscriber, phone SIP user agent 180 initiates a SIP INVITE to a SIP URI based on calls placed by the subscriber and in accordance with a dial plan and call handling parameters for processing the calls. In some cases the SIP URI represents the gateway SIP user agent 260 of the same subscriber voice-over-Internet device 160.

Subscriber voice-over-Internet device 160 further comprises memory 250 which is configured with a device identifier store 252 and a platform location store 254. Device identifier store 252 includes a unique device identifier for the present subscriber voice-over-Internet device 160 and may include device identifiers associated with similarly configured remotely located subscriber voice-over-Internet devices that have been identified over time. Platform location store 254 includes one or more uniform resource identifiers that identify the location of the voice-over-Internet platform 110. In addition, memory 250 may include one or more client components such as configuration information 256 and one or more add-on service clients 258 that enable the operation of one or more associated add-on telephonic services when a communication device is coupled and operational via the PSTN or the data network.

A number of operational modes are considered. In general, each subscriber voice-over-Internet device 160 is assigned a unique device identifier, which is stored in device identifier store 252 of memory 250. Each unique device identifier in turn is assigned credentials that confirm the subscriber voice-over-Internet device 160 should be permitted to communicate with voice-over-Internet platform 110.

In a bootstrap mode, the subscriber voice-over-Internet device 160 forwards the device identifier stored in device identifier store 252 and the assigned credentials to the voice-over-Internet platform. The voice-over-Internet platform 110 confirms the combination of the device identifier and the assigned credentials and shares a key that the subscriber voice-over-Internet device 160 uses to secure all future communications with the voice-over-Internet platform 110.

Once secure communications have been established by successful completion of the bootstrap procedure, the subscriber voice-over-Internet device 160 and the voice-over-Internet platform 110 engage in a one-time activation process. During the activation process, the subscriber voice-over-Internet device 160 registers with the voice-over-Internet platform 110, provides information that identifies its location, and issues a request to configure the device. The voice-over-Internet platform 110 instructs the subscriber voice-over-Internet device 160 to initiate a call via the PSTN to the voice-over-Internet platform 110. Upon receiving the call, the voice-over-Internet platform 110 instructs the subscriber voice-over-Internet device 160 to request a configuration update. The subscriber voice-over-Internet device 160, in turn, requests a configuration update via the data network. The voice-over-Internet platform 110 responds to the request by forwarding operational parameters to the subscriber voice-over-Internet device 160 via the data network. The subscriber voice-over-Internet device 160 uses the operational parameters when processing subsequent inbound and outbound calls. The configuration update includes operational parameters consistent with the location of the subscriber voice-over-Internet device 160 and one or more telephonic add-on services that are made operable via one or more of the voice-over-Internet platform 110 and the subscriber voice-over-Internet device 160.

Upon completion of the one-time activation procedure, the subscriber voice-over-Internet device 160 is configured to forward outgoing calls identified by a destination number in accordance with a dial plan established during the activation process. For example, some local (PSTN) calls including “911” emergency calls and calls to destination numbers that are not configured with a voice-over-Internet device 160 are forwarded to POTS interface 230, whereas long-distance calls to a destination number associated with a voice-over-Internet device 160 are forwarded via data interface 220 and data network 230 to the intended VoIP/SIP endpoint. Signaling information is processed by one or both of the voice-over-Internet platform 110 and the subscriber voice-over-Internet device 160. Voice band data may take one of several alternative routes as instructed by one or both of the subscriber voice-over-Internet device 160 and the voice-over-Internet platform 110. Voice band calls forwarded by POTS interface 230 trigger a data request that is forwarded over data interface 220 and the data network to determine if data store 310 includes information regarding the party associated with the called number. When the called party has a configured subscriber voice-over-Internet device 160, the calling subscriber's dial plan is updated to reflect that calls to the called party can be processed over the data network. Subsequent attempts to contact the called party can be automatically directed over the data network. Alternatively, the calling party could be presented with an option to route future calls over a select medium (e.g., the PSTN or the data network). For inbound VoIP calls originating from a compatible subscriber voice-over-Internet device, signaling information is processed by one or both of the voice-over-Internet platform 110 and the subscriber voice-over-Internet device 160. Voice band data may take one of several alternative routes as instructed by one or both of the subscriber voice-over-Internet device 160 and the voice-over-Internet platform 110. Call forwarding, distinctive ring, and other settings entered via the handset interface 215 also apply. For inbound PSTN calls, caller identification information is forwarded to one or both of the voice-over-Internet platform 110 and the subscriber voice-over-Internet device 160. Calls may be delivered locally via handset interface 215 or to an external SIP endpoint (as defined by configuration call forwarding/routing pattern rules). Calls delivered locally or forwarded to an external SIP endpoint are logically the same. In addition, subscriber voice-over-Internet device 160 may be configured to provide VoIP to PSTN call routing for inbound VoIP calls. To handle such calls, the subscriber voice-over-Internet device 160 may rely on SIP digest authentication to correctly route the call.

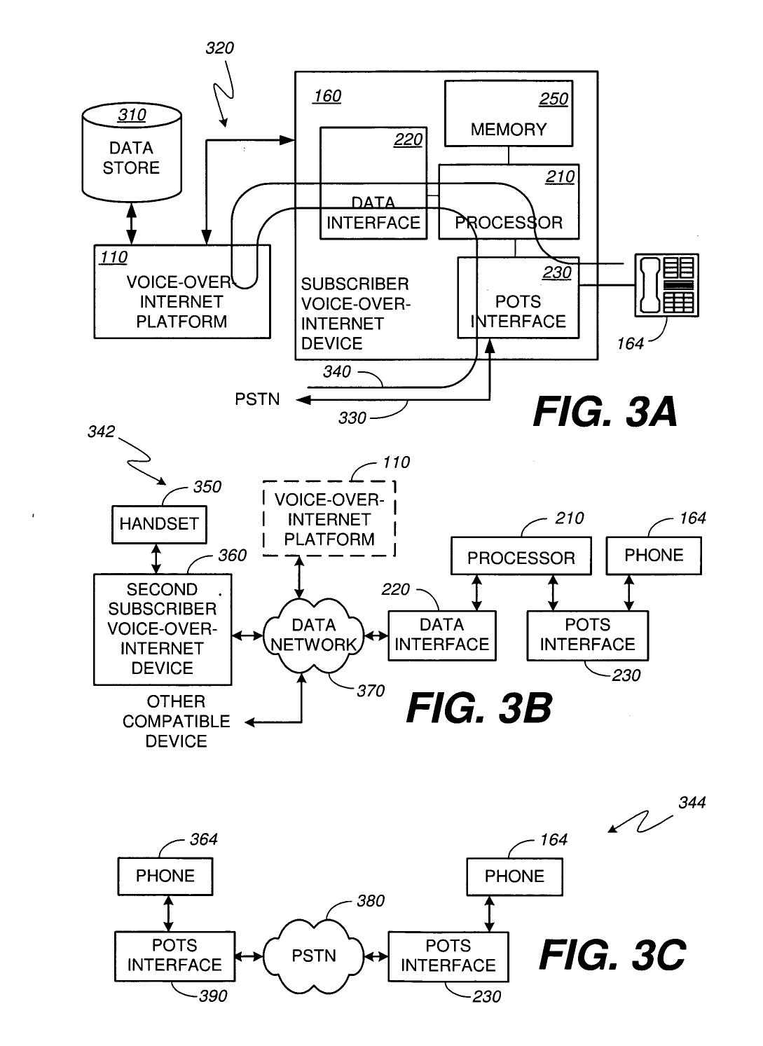

FIGS. 3A-3C are block diagrams illustrating various embodiments of signaling and communication paths for processing calls using components of the system of FIG. 1. The embodiment of a telecommunication system illustrated in FIG. 3A includes telephone 164, subscriber voice-over-Internet device 160, data network 320, voice-over-Internet platform 110, and data store 310. For simplicity of illustration and discussion the handset interface 215 introduced and described in association with FIG. 2 is omitted. In this regard, FIG. 3A is a schematic diagram that illustrates a signaling path 340 that is used to direct the processing of one or more calls between data network coupled end points (not shown) or PSTN coupled endpoints (not shown) and telephone 164. Signaling path 340 is representative of the route traversed by out-of-voice band signals that support call establishment, routing and information exchange for both wire-line and wireless telecommunications networks. These out-of-voice band signals traverse POTS interface 230, processor 210, data interface 220, and data network 320 on the way from the PSTN to voice-over-Internet platform 110. Thereafter, the out-of-voice band signals traverse the data network 320, data interface 220, processor 210, and POTS interface 230 on the way from voice-over-Internet platform 110 to telephone 164.

In the embodiment illustrated in FIG. 3A, the PSTN is coupled to POTS interface 230 of the subscriber voice-over-Internet device 160 via landline 330. In alternative embodiments, subscriber voice-over-Internet device 160 may be coupled to the PSTN via an intermediate wireless network and a wireless interface 235. In still other embodiments a wireless network and wireless interface 235 may replace the PSTN and POTS interface 230 entirely.

FIG. 3B is a schematic diagram that illustrates a first communication pathway 342 for processing a call between a data network coupled handset 350 or other compatible devices and telephone 164. In the illustrated embodiment, audio information picked up by telephone 164 is forwarded via POTS interface 230 to processor 210, which contains an analog to digital converter for transforming the analog audio signal to a digital signal. Processor 210 formats and buffers the received digital signal before forwarding the modified digital signal in the form of data packets via data interface 220 and data network 370. Data network 370 routes the data packets carrying the digital signal via a second subscriber voice-over-Internet 360 coupled to handset 350 or to one or more other compatible devices. For simplicity of description and illustration the various components contained within the second voice-over-Internet device 360 are omitted. It should be understood that the digital signal is buffered and converted in a digital to analog converter in the handset 350 or second subscriber voice-over-Internet device 360 to complete the call with an operator of handset 350. It will be further understood that audio information in the vicinity of handset 350 will be similarly converted, formatted, and buffered in the combination of handset 350 and second subscriber voice-over-Internet device 360 for transmission through data network 370, data interface 220, processor 210, POTS interface 230 and telephone 164.

Voice-over-Internet platform 110 is included in FIG. 3B to indicate that under some circumstances call information may be forwarded via data network 370 to voice-over-Internet platform 110 for further processing. Example circumstances include functions that are enabled via voice recognition and or DTMF inputs. Other examples may include forwarding the digital signal to an additional data network coupled host that includes previously registered code configured to enhance the communication session between handset 350 and telephone 164. In this way, the subscriber voice-over-Internet devices 160, 360 and the voice-over-Internet platform 110 can dynamically modify both the connectivity and operation of a call between telephone 164 and handset 350 or other compatible communication devices coupled to data network 370.

FIG. 3C is a schematic diagram that illustrates a second communication pathway 344 for processing a call between a data network coupled handset 350 or other compatible devices and telephone 164. In the illustrated embodiment, audio information picked up by telephone 164 is forwarded via POTS interface 230 through PSTN 380 to POTS interface 390 on to telephone 364. Similarly, audio information in the vicinity of telephone 364 is picked up and transferred via POTS interface 390 through PSTN 380 and POTS interface 230 on its way to telephone 164.

Other communication pathways in addition to those illustrated in FIGS. 3B and 3C are also contemplated. These additional communication pathways comprise a wireless medium. For example, in some circumstances the combination of voice-over-Internet platform 110 and subscriber voice-over-Internet device 160 can be configured to direct call information not only to and from end-user wireless communication devices, but a wireless network as well. When this alternative medium is used, the subscriber's wireless service provider processes the call and may or may not handle portions of any associated signaling and DTMF entries.

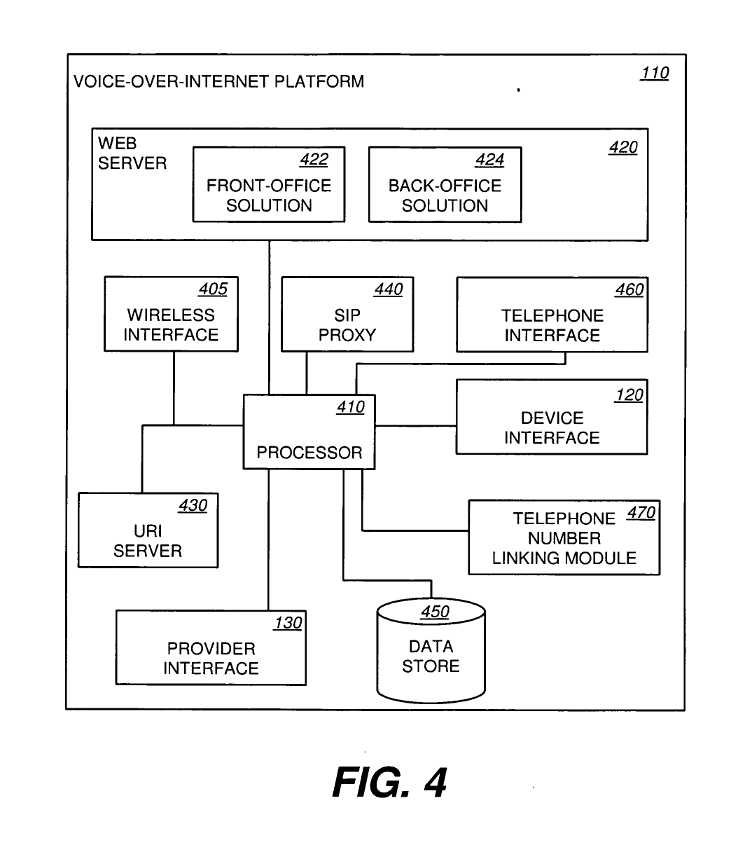

FIG. 4 is a functional block diagram illustrating an embodiment of the voice-over-Internet platform 110 of FIG. 1 for providing various voice-over-Internet services to subscriber voice-over-Internet device(s) 160. As illustrated in the embodiment of FIG. 4, voice-over-Internet platform 110 comprises device interface 120, provider interface 130, processor 410, wireless interface 405, web server 420, a uniform resource identifier (URI) server 430, SIP proxy 440, data store 450, telephone interface 460, and a telephone number linking module 470. It should be appreciated that the components of voice-over-Internet platform 110 may be distributed across one or more computer systems at any number of physical locations. Furthermore, it should be appreciated that some of the functional aspects of voice-over-Internet platform 110 may be located locally at customer voice-over-Internet device(s) 160.

The telephone number linking module 470 comprises the logic, functionality, etc. for provisioning subscriber voice-over-Internet device 160. Telephone number linking module 470 controls the process of associating, matching, linking, etc. the subscriber's existing telephone number (e.g., received via the telephone call) to the device identifier 352 (FIG. 3) associated with subscriber voice-over-Internet device 160 (e.g., received via the data session)—if a transmitted session identifier received via the telephone call matches a session identifier associated with the data session. In other words, telephone number linking module 470 integrates the functions of wireless interface 405, web server 420, SIP proxy 440, telephone interface 460, URI server 430, and data store 450 to create the telephone number/device identifier pairings used to facilitate voice-over-Internet communications between subscribers with similarly configured subscriber voice-over-Internet devices 160. The telephone number/device identifier pairing(s) created during the provisioning process may be stored in data store 450. URI server 430 may access data store 450 in order to provide voice-over-Internet services.

Web server 420 controls communications with customer voice-over-Internet device(s) 160 and other data communications devices associated with subscribers, such as computers, personal digital assistants and the like via the data network or a wireless network. Web server 420 further controls communications with service providers 170. Web server 420 may support any suitable communication protocol. For instance, web server 420 may be configured as a secure server which employs the hypertext transfer transport protocol (HTTP) (secure)—HTTPS. Furthermore, some communications may be performed via HTTPS, while other communications may be performed over less secure channels, such as HTTP.

As illustrated in FIG. 4, web server 420 comprises front-office solution 422 and back-office solution 424. Front-office solution comprises one or more modules for communicating information between voice-over-Internet platform 110 and the community of subscribers and potential subscribers of various telephonic services. In example embodiments, front-office solution 422 includes service, checkout, and configuration subscriber interfaces configured to enable subscribers to review, identify, purchase, and configure select services available from service provider 170 or the operator of voice-over-Internet platform 110. Back-office solution 424 comprises one or more modules for communicating information between voice-over-Internet platform 110 and the community of service providers and potential service providers of various telephonic services. In example embodiments, back-office solution 424 includes business relationship, service registration, service verification, subscriber usage, and billing interfaces configured to enable service providers to interact with voice-over-Internet platform 110. Various modules or portions of modules of the front-office solution 422 and back-office solution 424 may be shared as may be desired.

In another embodiment, voice-over-Internet platform 110 employs a session initiation protocol (SIP), which is described in detail in the following Requests for Comment (RFC) of the Internet Engineering Task Force (IETF), each of which are hereby incorporated by reference in their entirety: RFC 2543—SIP: Session Initiation Protocol; RFC 3261—SIP: Session Initiation Protocol; RFC 3262—Reliability of Provisional Responses in SIP; RFC 3263—Location SIP Servers; RFC 3264—An Offer/Answer Model with SDP; and RFC 3265—SIP-Specific Event Notification. In this embodiment, voice-over-Internet platform 110 comprises a SIP proxy 440 for supporting the session initiation protocol.

Whereas data communications occur via web server 420 (and perhaps SIP proxy 440), communications with customer voice-over-Internet device 160 via the PSTN are handled via telephone interface 460. Telephone interface 460 comprises any suitable interface for facilitating communication via the PSTN. Telephone interface 460 may be further integrated with IVR and touch tone functionality. Similarly, wireless interface 405 comprises any suitable interface for facilitating communication via a wireless communication network. As with telephone interface 460, wireless interface 405 may be further integrated with IVR and touch tone functionality as well.

Uniform resource identifier (URI) server 430 provides query capabilities for compatible voice-over-Internet end points (e.g., customer voice-over-Internet device 160). A compatible voice-over-Internet device 160 may query URI server 430 to obtain the identifier of a voice-over-Internet device stored in data store 450. It should be appreciated that, in an alternative embodiment, URI server 430 and/or data store 450 may further employ the ENUM system, which is defined in RFC 2916, RFC 2782, and RFC 3403, each of which are hereby incorporated by reference in their entirety.

As known in the art, SIP proxy 440 refers to any of a variety of individual SIP-related functions, roles, etc. (or a collection thereof), which may be distributed over a communications network. By way of example, depending on the particular function, SIP proxy 440 may include any of the following, or other, client and/or server roles: proxy, registrar, back-to-back user agent, etc.

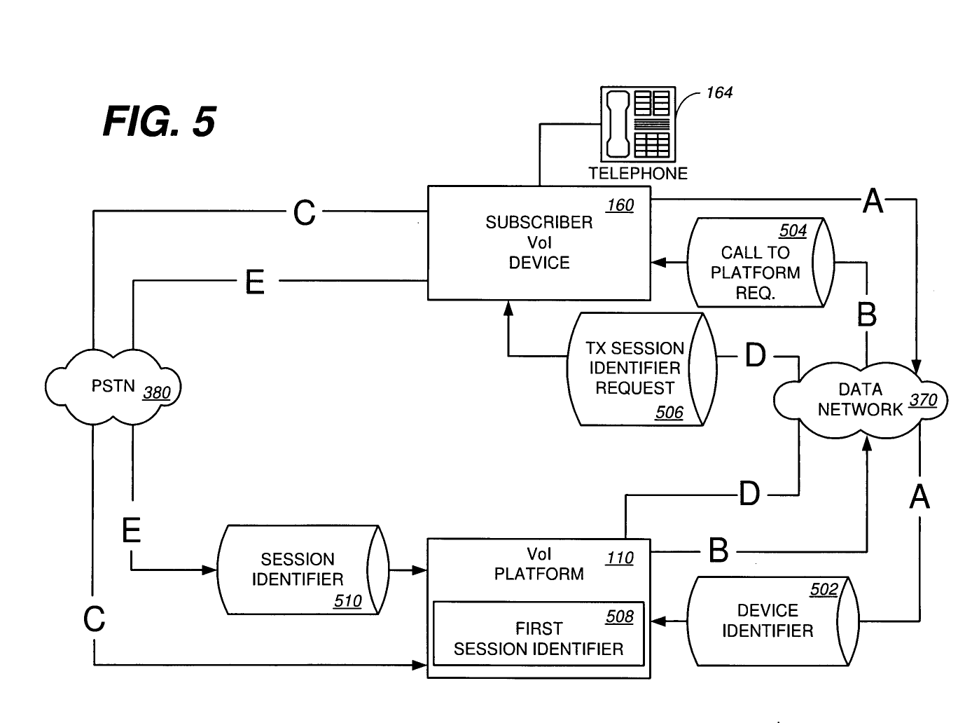

FIG. 5 is a combined block diagram and flow diagram that illustrates an embodiment of a method for provisioning subscriber voice-over-Internet device 160 in the voice-over-Internet platform 110 of FIG. 1. FIG. 5 illustrates the communication between subscriber voice-over-Internet device 160 and voice-over-Internet platform 110 during another embodiment of a method for provisioning customer voice-over-Internet device 160. As illustrated in FIG. 5, voice-over-Internet platform 110 simultaneously controls communications with customer voice-over-Internet device 160 via PSTN 380 and data network 370. The provisioning method involves both a data session (data network 370) and a telephone call (PSTN 380). As described more below, voice-over-Internet platform 110 uses both connections to associate the customer's existing telephone number (received via the telephone call) to a device identifier associated with customer voice-over-Internet device 160 (received via the data session)—if a transmitted session identifier received via the telephone call matches a session identifier associated with the data session. In this manner, customer voice-over-Internet device(s) 160 are automatically configured for the provision of voice-over-Internet services with little or no demands on customer interaction. The data session between customer voice-over-Internet device 160 and voice-over-Internet platform 110 is represented in FIG. 5 with references lines A, B and D, while the telephone call is represented by reference lines C and E.

As illustrated by reference line A, subscriber voice-over-Internet device 160 transmits a device identifier 502 to voice-over-Internet platform 110 via data network 370. Voice-over-Internet platform 110 may authenticate customer voice-over-Internet device 160 based on device identifier 502. Furthermore, voice-over-Internet platform 110 may generate a first session identifier 508 to identify the data session with customer voice-over-Internet device 160. Voice-over-Internet platform 110 provides a call-to-platform request 504 (reference line B) to subscriber voice-over-Internet device 160. Call-to-platform request 504 instructs subscriber voice-over-Internet device 160 to initiate the telephone call to voice-over-Internet platform 110. Subscriber voice-over-Internet device 160 initiates the telephone call to voice-over-Internet platform 110 via PSTN 380 (reference line C). Voice-over-Internet platform 110 determines the existing telephone number corresponding to subscriber voice-over-Internet device 160 by, for example, the ANI service mentioned above. Voice-over-Internet platform 110 provides a transmit-session-ID request 506 to subscriber voice-over-Internet device 160 via data network 370. Request 506 instructs subscriber voice-over-Internet device 160 to transmit session identifier 510 via the telephone call. If the transmitted session identifier 510 matches the first session identifier 508, voice-over-Internet platform 110 associates the subscriber's existing telephone number with subscriber voice-over-Internet device 160, and provisions the device for voice-over-Internet services.

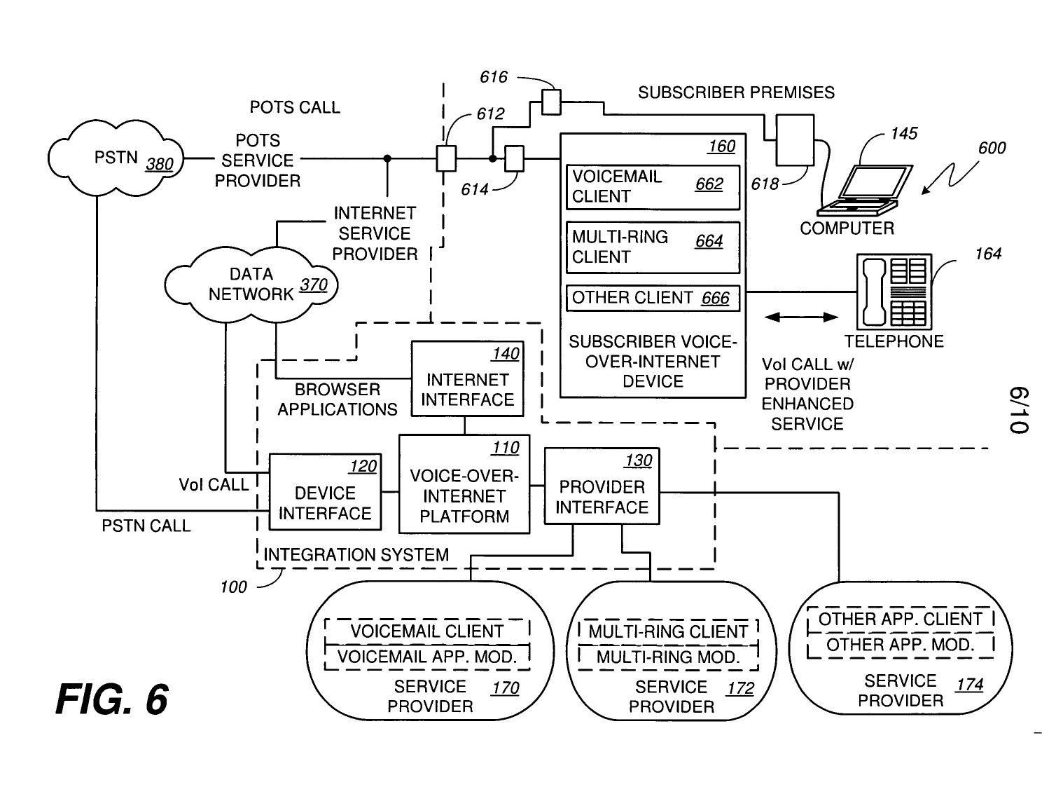

FIG. 6 is a schematic diagram illustrating an embodiment of an operational environment 600 in which the integration system 100 of FIG. 1 and the subscriber voice-over-Internet device 160 of FIG. 2 enable landline customers to subscribe to services from service providers 170. Operational environment 600 comprises integration system 100, which couples service providers 170, 172, 174 to subscriber voice-over-Internet device 160 to expose subscribers to add-on telephonic services supplied by the service providers. As illustrated in FIG. 6, subscriber premises comprises an RJ-11 or other connection 614, which couples an existing telephone line provided by a POTS service provider to subscriber voice-over-Internet device 160. Connection 616, also coupled via the PSTN 380 may provide data network service to the subscriber premises. In the illustrated embodiment, broadband modem 618 coupled to connection 616 provides data network service to subscriber voice-over-Internet device 160. Subscriber voice-over-Internet device 160 is coupled to one or more telephonic handsets or telephones such as telephone 164. Subscriber premises may also have one or more devices configured to interface with data network 370 such as computer 145. Computer 145 can be used by a subscriber to interact with voice-over-Internet platform 110 using one or more web browsers or other suitably configured applications to manage a subscriber account, shop for telephonic services, check on usage statistics, etc. In addition to enabling the above-mentioned account management functions, computer 145 could be configured to execute application software configured to initiate, answer, or place calls over the existing POTS telephone line.

Note that while subscriber computer 145 is located within subscriber premises, subscriber communications via data network 370 to voice-over-Internet platform 110 may be enabled from devices located outside the subscriber premises. For example, a subscriber away from home equipped with a mobile device with a web browser can access and communicate with Internet interface 140 of integration system 100 over data network 370. In addition, a subscriber away from home or someone with access privileges granted by the subscriber may use an Internet connection to place a call over the existing POTS line within the subscriber premises, even when the computer 145 and subscriber are located hundreds or even thousands of miles away from home.

While the broadband data service is shown in the described embodiments as being coupled to the subscriber voice-over-Internet device 160 via the telephone line, the connection to the data network is not limited to the telephone line. For example, a link to the data network may comprise a radio frequency, an infra-red or other known or later developed wireless communication media.

PSTN 380 and data network 370 couple device interface 120 of the integration system 100 to the subscriber premises via a network interface device 612. Data network 370 is also coupled to integration system 100 via Internet interface 140.

As further illustrated in FIG. 6, service providers 170, 172, and 174 are communicatively coupled to integration system 100 via provider interface 130. Provider interface 130 is configured with functional modules which support front-office activities, such as but not limited to communications, provider registration, accounting, quality assurance standards verification, and security. Additionally or alternatively, each of the service providers 170, 172, and 174 or potential service providers (not shown) may communicate with integration system 100 via Internet interface 140 and data network 370. These additional or alternative communications are well suited for establishing business relationships, identifying operational interfaces, communicating offers and subscriber information, transferring modules or client components, and verifying the same.

In the illustrated embodiment, each of the service providers 170, 172, and 174 transfers a respective add-on service application module and/or an associated configuration or add-on service subscriber client component via the integration system to the voice-over-Internet platform 110 or subscriber voice-over-Internet device 160, respectively. Service provider 170 provides a voicemail application module that can be stored and made operable for telephone 164 via voice-over-Internet platform 110. Service provider 170 further provides a configuration item or voicemail client 662 via integration system 100 and data network 370. Application modules and client components that are uploaded or otherwise transferred from service providers 170, 172, and 174 may include a set of executable instructions for performing designated functions. In some embodiments, application modules and client components may comprise information that is used by the subscriber voice-over-Internet device 160 and voice-over-Internet platform 110 to enable particular functions.

Service provider 172 provides a multi-ring application module that can be stored and made operable for telephone 164 via voice-over-Internet platform 110. Service provider 172 further provides a configuration item or multi-ring client 664 via integration system 100 and data network 370. Service provider 174 provides other service application module that can be stored and made operable for telephone 164 via voice-over-Internet platform 110. Service provider 174 further provides a configuration item or other add-on service client 666 via integration system 100 and data network 370. In this way, additional add-on service modules and client components may be mixed with these or other add-on services that can enhance the operation of all communications made via telephone 164, whether the communication is a PSTN call, a cellular or other wireless call, or a voice-over-Internet call.

In alternative embodiments (not shown), service providers 170, 172, and 174 do not transfer or otherwise communicate code that is sent to the subscriber voice-over-Internet device 160. In these alternative embodiments, a service provider registers application code that provides the desired function(s) under the control of one or both of the voice-over-Internet platform 110 and the subscriber voice-over-Internet device 160. Application code is activated and executed under the control of one or both of the voice-over-Internet platform 110 and the subscriber voice-over-Internet device 160 whether the application code is stored within the voice-over-Internet platform 110 or external host(s) (not shown) coupled to data network 370.

It is significant to note that application code need not be written in a hardware specific programming language. Application code can be written in a host of different known or later developed programming languages. Programming languages may comprise practical extraction and reporting language (PERL) scripts, hypertext preprocessor (a HTML-embedded scripting language) or PHP, extensible markup language (XML) among others. In this way, potential service providers can enable functions operable via the combination of the voice-over-Internet platform 110, the subscriber voice-over-Internet device 160, and perhaps other hosts coupled via the data network 370 using familiar programming languages and techniques.

The provider services that can be made operable by the above described system and methods can mimic present services available from the POTS or cellular (phone) service provider that services the subscriber. These services may be provided by service providers at rates other than those presently available to phone service subscribers. More importantly, as long as the modules and client components meet the operational requirements set forth by the operator of the voice-over-Internet platform 110, the various provider services are limited only by the ingenuity of the various service providers and the desires of the exposed subscriber community. A service provider can use the integration system 100 to reach subscriber markets in a fraction of the time it presently takes to convince POTS and cellular service providers to investigate and decide whether to offer a new add-on service to their subscribers.

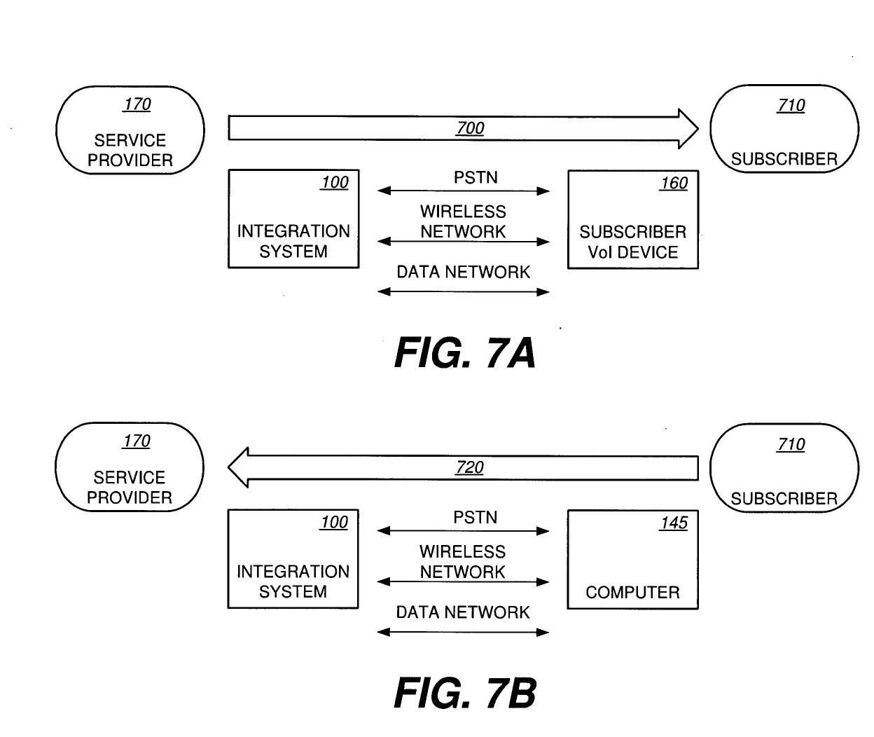

FIG. 7A is a schematic diagram illustrating an embodiment of a channel 700 that integrates telephonic service providers such as service provider 170 with subscriber 710 that can be implemented by the integration system 100 of FIG. 1 and the subscriber voice-over-Internet device 160 of FIG. 2. As indicated in FIG. 7A, forward channel 700 extends from service provider 170 to subscriber 710. Forward channel 700 traverses integration system 100 one or more of the PSTN, a wireless network, and a data network before arriving at subscriber voice-over-Internet device 160. Subscriber 710 interfaces with subscriber voice-over-Internet device 160 via a telephonic device (not shown).

FIG. 7B is a schematic diagram that illustrates an embodiment of a reverse channel 720 that integrates subscriber 710 via computer 145 and one or more of the PSTN, a wireless network, and a data network with integration system 100. As described above, computer 145 can be located anywhere a subscriber can access the PSTN, a wireless network, or data network. Application software operable on computer 145 can be used by subscriber 710 to access, review, subscribe, and configure available telephonic add-on services as exposed by the front-office solution 422 of web server 420 (FIG. 4).

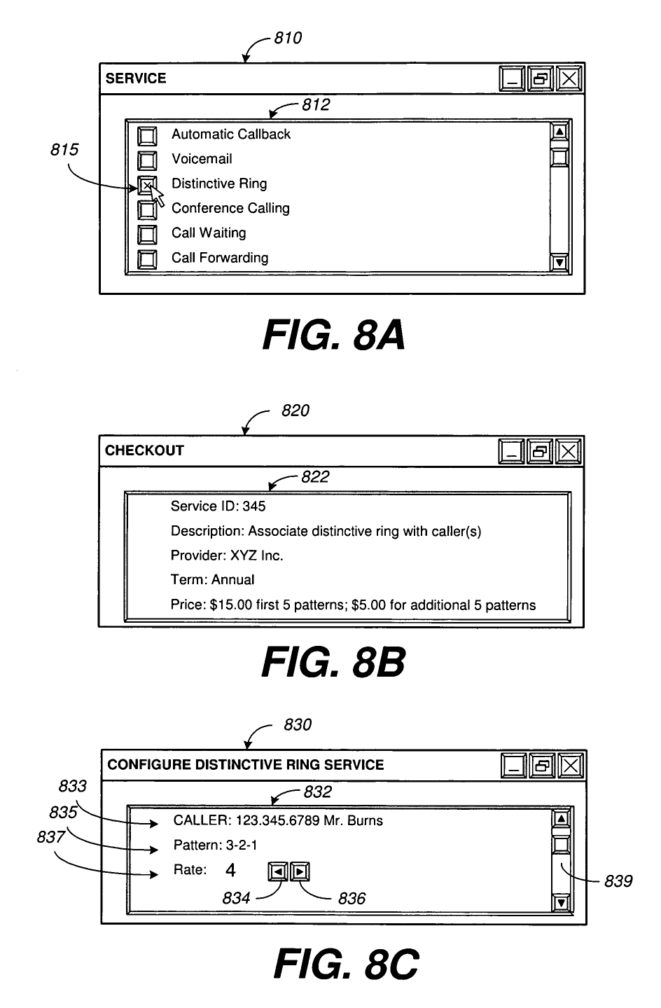

FIG. 8A is a schematic diagram illustrating an example embodiment of graphical user interface 810 that is generated by the front-office solution 422. Interface 810 comprises a selection field 812 where available add-on services can be selected by a subscriber in communication with the front-office solution 422. Selection field 812 comprises a set of associated pushbuttons and service names. In the example embodiment, pushbutton 815 associated with a select service for applying a distinctive ring to incoming calls is selected by an operator of a software application in communication with front-office solution 422. Pushbuttons, such as pushbutton 815 can be selected by manipulating a pointing device over the interface until a cursor under the control of the pointing device is positioned over the pushbutton 815. Once the cursor is positioned as intended, the state of pushbutton 815 (and other pushbuttons) can be modified by striking an appropriately configured switch associated with the pointing device or striking an appropriately configured key on a keyboard. In alternative embodiments, the front-office solution 422 is configured with voice activated menus that enable a subscriber to interact with front-office solution 422.

FIG. 8B is a schematic diagram illustrating an example embodiment of a graphical user interface 820 that is also generated by front-office-solution 422. Interface 820 comprises information field 822 where details regarding a select service are presented to an operator of software in communication with front-office solution 422. As further illustrated in FIG. 8B, information field 822 comprises a set of labels that are each associated with a respective alphanumeric data string. In the example embodiment, the distinctive ring service has a service identifier of “345,” a description of “Associate distinctive ring with caller(s),” a provider name of “XYZ Inc.,” a subscription term of “annual,” and a subscription price of $15.00 for the first 5 patterns and an additional $5.00 for an additional 5 patterns.

FIG. 8C is a schematic diagram illustrating an example embodiment of a graphical user interface 830 that is also generated by front-office-solution 422. Interface 830 comprises information field 832 where details regarding a caller and an associated distinctive ring pattern identifying incoming calls from that caller are presented to an operator of software in communication with front-office solution 422. As further illustrated in FIG. 8C, information field 832 comprises a set of labels that are each associated with a respective alphanumeric data string. In the example embodiment, the caller 833 is associated with both the caller's destination (i.e., phone number) and the caller's name. Pattern 835 is associated with a label identifying a selective ring pattern (e.g., 3-2-1) that will be generated when the subscriber receives a call from Mr. Burns. Rate 837 is associated with a numeric value indicative of the rate at which the distinctive ring pattern will be played at the telephonic device. Pushbutton 834, when selected, adjusts rate 837 to decrease the speed or tempo at which the distinctive ring pattern is played on the telephonic device. Conversely, pushbutton 836, when selected, adjusts rate 837 to increase the speed or tempo at which the distinctive ring pattern is played on the telephonic device. Slide control 839 and the associated pushbuttons enable an operator of the software to scroll through a list of callers such as those that might be stored and accessible via a subscriber's address book. Other interfaces suited for each add-on service available via voice-over-Internet platform 110 may be generated and provided by front-office solution 422 as desired.

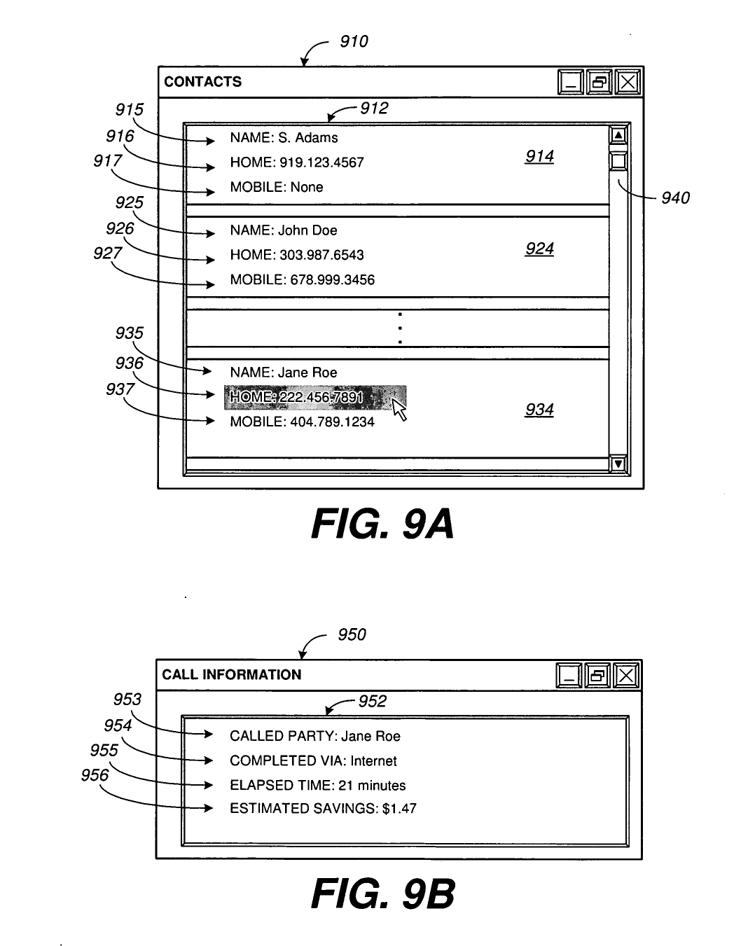

FIG. 9A is a schematic diagram illustrating an example embodiment of a graphical user interface 910 that is generated by an application programming interface operable on computer 145. Interface 910 comprises information field 912 where details regarding a plurality of subscriber contacts are presented to an operator of computer 145. As further illustrated in FIG. 9A, information field 912 comprises contact panel 914, contact panel 924, through contact panel 934, with each respective contact panel including a set of labels that are each associated with a respective alphanumeric data string.

In the example embodiment, contact panel 914 includes name field 915, which is populated with “S. Adams.” Contact panel 914 further includes home field 916, which includes a nine digit telephone service destination number to call S. Adams at home and mobile field 917, which is empty. Contact panel 924 is associated with a second contact. Contact panel 924 includes name field 925, which is populated with “John Doe.” Home field 926, which includes a nine digit telephone service destination number to contact John Doe at home and mobile field 927, which includes a nine digit destination number to call John Doe via a cellular phone, are also included in contact panel 924. Contact panel 934 includes name field 935, home field 936, and mobile field 937. Contact panel 934 further includes cursor 939 which is located above Jane Roe's home number field 936. If an operator of computer 145 selects home number field 936 by depressing a pushbutton associated with a pointing device responsible for directing the movement and operation of cursor 939 within graphical user interface 910, the application programming interface operable on computer 145 directs the subscriber voice-over-Internet device to initiate a call with Jane Roe. In preferred embodiments, the subscriber voice-over-Internet device 160 is configured to route the subsequent call via a compatible voice-over-Internet device coupled to a telephonic device at Roe's residence. When Jane Roe has not installed a compatible subscriber voice-over-Internet device 160 and completed the initialization or bootstrap procedure and a one-time activation procedure to configure the device, the subscriber's voice-over-Internet device 160 is configured to complete the call through other communication pathways. These other communication pathways include a wireless network (when both parties have wireless handsets and subscriber voice-over-Internet devices 160 configured with wireless interfaces) and the PSTN 380. Thus, an operator of computer 145 can initiate a call via alternative communication pathways. Slide control 940 and the associated pushbuttons enable an operator of the computer 145 to scroll through a list of contacts such as those that might be stored and accessible via a subscriber's address book. As described above, calls can be connected to any of the contacts.

FIG. 9B is a schematic diagram illustrating an example embodiment of a graphical user interface 950 that is generated by an application programming interface operable on computer 145. Interface 950 comprises information field 952 where details regarding a current call in progress, such as the call initiated to Jane Roe, are presented to an operator of computer 145. In the example embodiment, contact panel 952 includes called party field 953, call completed field 954, elapsed time field 955, and estimated savings field 956 each of which are populated with suitable alphanumeric strings responsive to the respective field. In this way, an operator of computer 145 can observe information regarding a current call. Alternatively, an operator of computer 145 can elect to initiate other graphical user interfaces configured to present configuration information, including subscriber plans, call logs, and other information as desired. For example, call logs can include information indicative of whether the call was initiated or received, the party associated with the source/destination, when the call was connected, when the call was terminated, the duration of the call, cost associated with the call, etc.

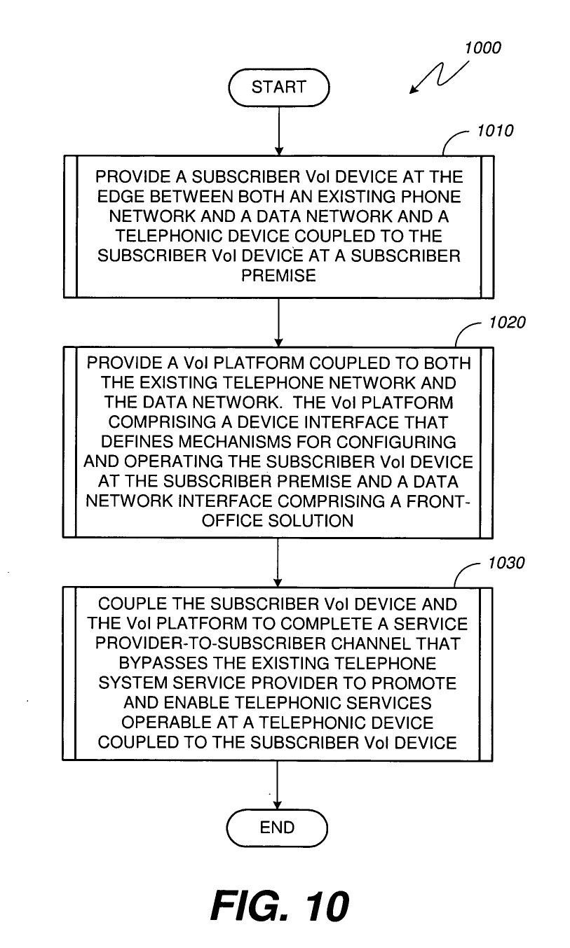

FIG. 10 is a flow diagram illustrating an embodiment of a method 1000 for enabling a service provider to telephonic service subscriber channel that can be implemented by the integration system 100 of FIG. 1 and the subscriber voice-over-Internet device 160 of FIG. 2. As illustrated in FIG. 10, method 1000 begins with block 1010 where a subscriber voice-over-Internet device is provided at the edge between both the PSTN and a data network and a telephonic device coupled to the subscriber voice-over-Internet device at a subscriber premise. In block 1020, a voice-over-Internet platform coupled to both the existing telephone network and the data network is provided. The voice-over-Internet platform comprises a device interface that defines mechanisms for configuring and operating the subscriber voice-over-Internet device at the subscriber premise and a data network interface that comprises a front-office solution. The functionality described in blocks 1010 and 1020 can be performed substantially simultaneously or in reverse order from that presented above. In block 1030, the combination of the subscriber voice-over-Internet device and the voice-over-Internet platform is coupled to complete a service provider-to-subscriber channel that bypasses the existing telephone system service provider to promote and enable telephonic services operable at a telephonic device coupled to the subscriber voice-over-Internet device.

The flow diagram of FIG. 10 shows the architecture, functionality, and operation of a possible implementation via software and or firmware associated with a host of communicatively coupled hardware devices that enables the integration of one or more add-on services from one or more service providers with a voice-over-Internet platform 110 for communicating with similarly configured subscriber devices. In this regard, each block represents a module, segment, or portion of code, which comprises one or more executable instructions for implementing the specified logical function(s).

The operational software programs that may be used by the various devices of the integration system 100, as well as operational software that may be used in conjunction with browsers, telephonic devices, and applications that interface with integration system 100, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

While various embodiments of the systems and methods for integrating telephonic service subscribers have been described, it will be apparent to those of ordinary skill in the art that many more embodiments and implementations are possible that are within the scope of the accompanying claims. Accordingly, the systems and methods for integrating telephonic service subscribers are not to be restricted beyond the attached claims and their equivalents.

What is claimed is:

1. A telecommunication system comprising:
a first interface configured to enable a telephonic handset to communicate via a phone service;
a second interface configured to enable the telephonic handset to communicate via a data network;
a first voice-over-Internet device coupled to the first interface and the second interface, the first voice-over-Internet device configured to modify the phone service.

2. The telecommunication system of claim 1, wherein the phone service comprises a landline operable over the public switched telephone network.

3. The telecommunication system of claim 1, wherein the phone service is operable over a wireless network.

4. The telecommunication system of claim 1, wherein the first voice-over-Internet device performs a self-initialization procedure that binds a phone-service destination number with a unique voice-over-Internet identifier.

5. The telecommunication system of claim 1, wherein the first voice-over-Internet device is configured to communicate with a remote voice-over-Internet platform, the voice-over-Internet platform configured to adjust operation of the first voice-over-Internet device responsive to the phone-service destination number via a configuration procedure.

6. The telecommunication system of claim 5, wherein the first voice-over-Internet device is configured to route a call over the data network when a remote destination number is associated with a second voice-over-Internet device compatible with the first voice-over-Internet device.

7. The telecommunication system of claim 5, wherein the first voice-over-Internet device is configured to route a call via the phone service when an operator of the handset coupled to the first voice-over-Internet device selects a destination number that is not coupled to the data network and a compatible voice-over-Internet device.

8. The telecommunication system of claim 5, further comprising:
a website configured to enable a subscriber to manage the configuration of the first voice-over-Internet device.

9. The telecommunication system of claim 1, wherein the first voice-over-Internet device identifies when an operator of a handset coupled to the first voice-over-Internet device has selected an add-on feature and provides the feature responsive to a subscriber configuration.

10. The telecommunication system of claim 9, wherein when the add-on feature comprises a ‘911’ emergency call, the first voice-over-Internet device routes the call via a landline.

11. The telecommunication system of claim 9, wherein the subscriber configuration identifies a service enabled by the integration of the data network and the phone service at the first voice-over-Internet device and at the voice-over-Internet platform.

12. The telecommunication system of claim 11, wherein the service is subscriber configurable.

13. The telecommunication system of claim 11, wherein the service impacts the processing of inbound calls.

14. The telecommunication system of claim 11, wherein the service impacts the processing of outbound calls.

15. The telecommunication device of claim 1, further comprising:
an application programming interface operable on a computing device coupled to the data network, the application programming interface configured to enable a subscriber to manage the configuration of the voice-over-Internet device.

16. The telecommunication device of claim 15, wherein the application programming interface enables the subscriber to manage the behavior of the phone service coupled to the first voice-over-Internet device.

17. The telecommunication device of claim 16, wherein the application programming interface provides a graphical user interface that enables a subscriber to select information that is communicated to the voice-over-Internet device which is directed to initiate a call responsive to the select information.

18. The telecommunication device of claim 17, wherein the first voice-over-Internet device selectively routes the call.

19. The telecommunication device of claim 17, wherein the graphical user interface generates an indication when a call is being connected via the phone service or via the data network.

20. The telecommunication system of claim 1, wherein the first voice-over-Internet device is configured via the voice-over-Internet platform to route calls arriving from a select ingress port to a select egress port.

21. The telecommunication system of claim 19, wherein the ingress port and egress port are selected unconditionally.

22. The telecommunication system of claim 20, wherein the ingress port and egress port are selected conditionally.

23. A method for enabling a service provider to telephonic service subscriber channel, the method comprising:
providing a subscriber voice-over-Internet device at the edge between both an existing telephone network and a data network and a telephonic device coupled to the subscriber voice-over-Internet device at a subscriber premise;
providing a voice-over-Internet platform coupled to both the existing telephone network and the data network, the voice-over-Internet platform comprising a device interface that defines mechanisms for configuring and operating the subscriber voice-over-Internet device at the subscriber premise and a data network interface comprising a front-office solution; and
coupling the subscriber voice-over-Internet device to the voice-over-Internet platform to complete a service provider-to-subscriber channel that bypasses an existing telephone system service provider and enables a second service provider to promote and enable telephonic services operable at the telephonic device through the voice-over-Internet platform.

24. The method of claim 23, wherein providing a subscriber voice-over-Internet device comprises supplying a consumer retailer with a configurable plug-n-play device.

25. The method of claim 24, wherein the combination of the voice-over-Internet platform and the configurable plug-n-play device generate a systemic solution that exposes subscribers to non-traditional service providers.

26. The method of claim 23, wherein the front-office solution identifies telephonic services provided by the service provider.

27. The method of claim 23, wherein the front-office solution identifies telephonic services provided by an operator of the voice-over-Internet platform.

28. The method of claim 23, wherein the front-office solution presents a suite of services to potential subscribers.

29. The method of claim 23, wherein the front-office solution enables a potential subscriber to purchase a select service.

30. The method of claim 23, wherein the front-office solution enables a potential subscriber to purchase a suite of services.

31. The method of claim 23, wherein the front-office solution presents one or more options for a subscriber to configure a select service.

32. The method of claim 23, wherein the voice-over-Internet platform dynamically directs the voice-over-Internet device to route calls arriving from a select ingress port to a select egress port.
